(19) United States
(12) Patent Application Publication
(10) Pub. No.: US 2025/0004676 A1
(43) Pub. Date: Jan. 2, 2025

(54) STORAGE MEDIUM, INFORMATION PROCESSING APPARATUS, AND CONTROL METHOD FOR THE SAME

(71) Applicant: CANON KABUSHIKI KAISHA, Tokyo (JP)

(72) Inventor: Naoki Shinozuka, Kanagawa (JP)

(21) Appl. No.: 18/744,969

(22) Filed: Jun. 17, 2024

(30) Foreign Application Priority Data
Jun. 27, 2023 (JP) 2023-105202

(51) Int. Cl. G06F 3/12

(52) U.S. Cl. CPC G06F 3/1225; G06F 3/1205; G06F 3/1238; G06F 3/1253

(57) ABSTRACT

A storage medium according to the present disclosure is a non-transitory computer-readable storage medium storing a program for causing a computer to perform: control to install a predetermined printer driver with first privileges; referring to a set value of a particular setting option with second privileges different from the first privileges, the particular setting option indicating whether a default printer is managed by an OS; and controlling display of a display item for receiving an instruction related to whether to set a predetermined printer corresponding to the predetermined printer driver as the default printer in accordance with the referred set value of the particular setting option.

### BACKGROUND OF THE INVENTION

### Field of the Invention

The present disclosure relates to a technology of displaying a setting screen of a printing apparatus.

### Description of the Related Art

At printing, a user selects a printing apparatus (hereinafter referred to as a printer) at which printing is to be performed. An operating system (OS) has a function to set a frequently used printer as a default printer in advance. Accordingly, printing is possible without printer selection by a user.

Japanese Patent Laid-Open No. 2019-144766 discloses a method of controlling whether to display a screen for setting the default printer based on consideration of OS control to set a printer used at last printing as the default printer and a test print function. Hereinafter, OS control to set a printer used at last printing as the default printer is referred to as a default printer designation function.

The OS manages the activation state of the default printer designation function for each account. In a case where an information processing apparatus is activated with a general user account not having administrator privileges and a driver of a predetermined printer is to be installed on the information processing apparatus, the general user account is temporarily elevated to administrator privileges. Then, an application for installing the driver is activated with administrator privileges. Hereinafter, an application for installing a driver is referred to as an installer. In a case where the installer displays a screen for setting the predetermined printer as the default printer in the state of being temporarily elevated to administrator privileges, not information of the general user account but information of an account having administrator privileges is referred. Thus, there is a possibility that appropriate display cannot be performed.

### SUMMARY OF THE INVENTION

A storage medium according to an aspect of the present disclosure is a non-transitory computer-readable storage medium storing a program for causing a computer to perform: control to install a predetermined printer driver with first privilege; referring to a set value of a particular setting option with second privilege different from the first privilege, the particular setting option indicating whether a default printer is managed by an OS; controlling display of a display item for receiving an instruction related to whether to set a predetermined printer corresponding to the predetermined printer driver as the default printer in accordance with the referred set value of the particular setting option. Further features of the present invention will become apparent from the following description of exemplary embodiments with reference to the attached drawings.

### BRIEF DESCRIPTION OF THE DRAWINGS

FIG. 1 is a diagram illustrating an example of the entire configuration of a system;

FIG. 2 is a flowchart illustrating an example of processing at an installer;

FIGS. 3A, 3B, and 3C are diagrams illustrating an example of a screen displayed by the installer;

FIGS. 4A and 4B are flowcharts illustrating an example of default printer setting control by an OS;

FIGS. 5A and 5B are flowcharts illustrating an example of process activation processing by the OS;

FIGS. 6A, 6B, and 6C are diagrams illustrating an example of screen display by the OS;

FIG. 7 is a diagram showing the relationship of FIG. 7A and FIG. 7B, and FIG. 7A and FIG. 7B are flowcharts illustrating an example of default printer setting screen display determination processing;

FIGS. 8A and 8B are diagrams illustrating an example of a screen displayed by the installer; and

FIGS. 9A, 9B, and 9C are flowcharts illustrating an example of processing executed by the OS, a launcher app, and the installer.

### DESCRIPTION OF THE EMBODIMENTS

Embodiments of the present disclosure will be described below with reference to the accompanying drawings. Note that the embodiments below do not limit the present disclosure and all combinations of characteristics described in the embodiments below are not always essential for a solution of the present disclosure. Configurations described in the embodiments below are merely exemplary. In the following description, an information processing apparatus in the embodiments is, for example, a personal computer but not limited thereto, and the present disclosure holds for, for example, a tablet terminal as well.

### First Embodiment

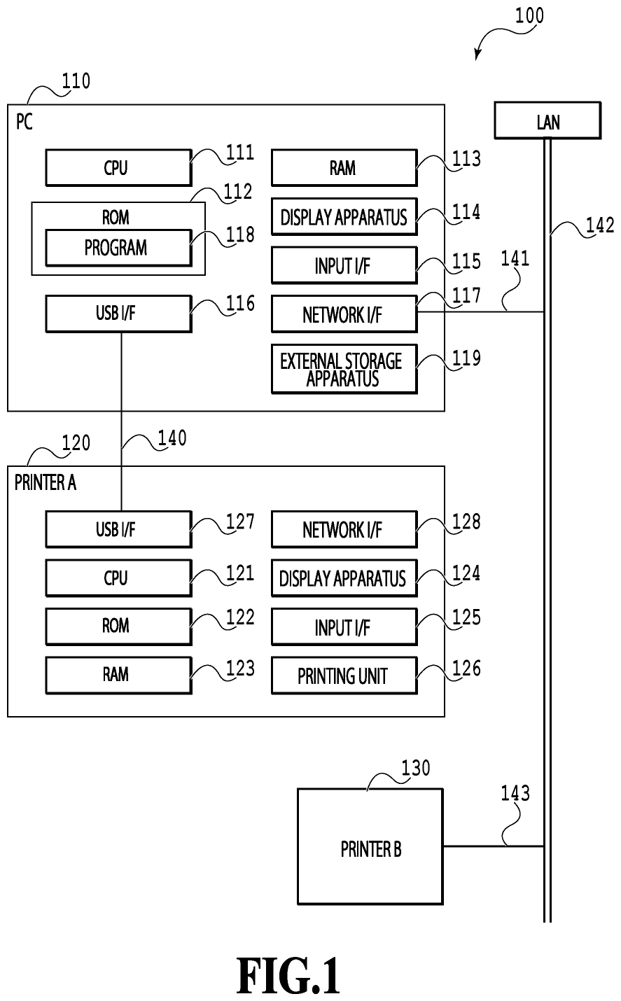

FIG. 1 is a diagram illustrating an example of the entire configuration of a system 100 including a personal computer 110, a printer A120, and a printer B130. Hereinafter, a personal computer is referred to as a PC or a computer.

The PC 110 operates as an information processing apparatus configured to control a printer. The PC 110 includes a CPU 111, a read only memory (ROM) 112, and a random access memory (RAM) 113. The PC 110 includes a display apparatus 114, an input interface (I/F) 115, a Universal Serial Bus (USB) I/F 116, a network I/F 117, and an external storage apparatus 119. The CPU 111 is a center processing unit and reads and executes a computer program 118 stored in the ROM 112. The ROM 112 is a non-transitory storage medium and stores the computer program 118 such as a printer driver or an installer to be described later. The RAM 113 is a system memory of the CPU 111 and used as a storage region such as a work area. The display apparatus 114 is an apparatus configured to display image information output from the PC 110. The input I/F 115 is an interface for inputting data to the PC 110. The USB I/F 116 is an interface for inputting and outputting data through a USB cable 140. The PC 110 can communicate with the printer A120 through the USB I/F 116. The network I/F 117 is an interface for connection from the PC 110 to a network. The PC 110 may include any one of the USB I/F 116 and the network I/F 117. The PC 110 can be connected to a LAN 142 by network connection 141 through an Ethernet (registered trademark) cable and/or a wireless local area network (LAN). The external storage apparatus 119 is an apparatus storing an operation system (OS) and various kinds of data.

The printer A120 includes a CPU 121, a ROM 122, a RAM 123, a display apparatus 124, an input I/F 125, a printing unit 126, a USB I/F 127, and a network I/F 128. The CPU 121, the ROM 122, the RAM 123, and the display apparatus 124 have the same function as the CPU 111, the ROM 112, the RAM 113, and the display apparatus 114, respectively, and description thereof is omitted. The input I/F 125, the USB I/F 127, and the network I/F 128 have the same function as the input I/F 115, the USB I/F 116, the network I/F 117, respectively, and description thereof is omitted. The printing unit 126 executes printing processing based on image data input from the PC 110 through the USB I/F 127. The printer A120 can be connected to and communicate with the PC 110 through the USB I/F 127 and the USB cable 140. Alternatively, the printer A120 may be connected to the LAN 142 by network connection (not illustrated) through the network I/F 128 and communicate with the PC 110.

The printer B130 is a printing apparatus having the same configuration as the printer A120. However, the printer B130 may have a different configuration from that of the printer A120. The printer B130 is connected to the LAN 142 through network connection 143 connected to a network I/F (not illustrated) and can communicate with the PC 110 connected to the same LAN. In a case where a plurality of USB I/Fs 116 are mounted on the PC 110 or in a case where a USB HUB (not illustrated) is used, the PC 110 can be simultaneously connected to a plurality of printers. Moreover, the PC 110 can be simultaneously connected to a plurality of printers through the LAN 142. In this manner, the PC 110 can be connected to and communicate with a plurality of printers. Thus, printers connected to the PC 110 in FIG. 1 are not limited to two of the printer A120 and the printer B130 but may be three or more printers.

In the above description with reference to FIG. 1, the PC 110 includes the USB I/F 116 and the network I/F 117 as I/Fs for connection to a printer (the printer A120 or B130), but may include only one of them. Although USB I/F and I/Fs are exemplarily described as connection I/Fs that are connectable to a printer (the printer A120 or B130), communication may be performed in accordance with a standard such as Bluetooth (registered trademark). Hereinafter, unless otherwise stated, the printer A120 will be described as a representative example of a printer in the present embodiment.

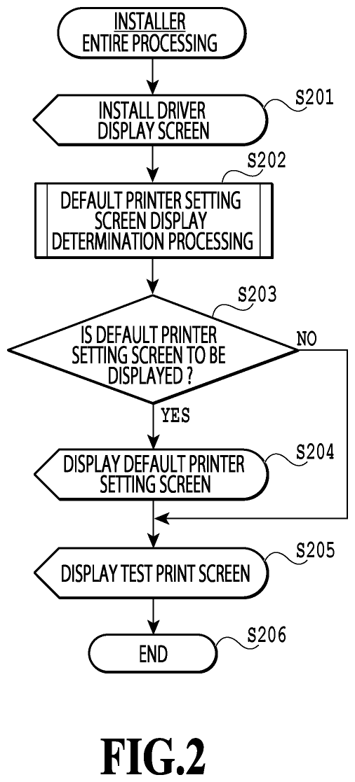

FIG. 2 is a flowchart illustrating an example of screen display processing that the CPU 111 executes as a function of an installer. Processing by the installer in the present embodiment will be described below with reference to FIG. 2. The installer is an application for installing a printer driver (not illustrated) and registering the printer A120 to the PC 110. The processing by the installer in FIG. 2 is achieved as the CPU 111 loads the computer program 118 stored in the ROM 112 onto the RAM 113 and executes the loaded computer program. Note that a symbol “S” in the following description of each processing means processing (step) in FIG. 2. This is the same in the following description of any other flowchart.

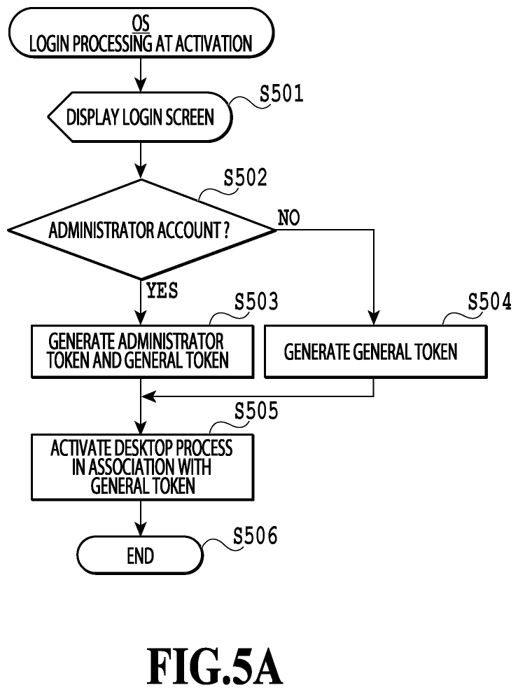

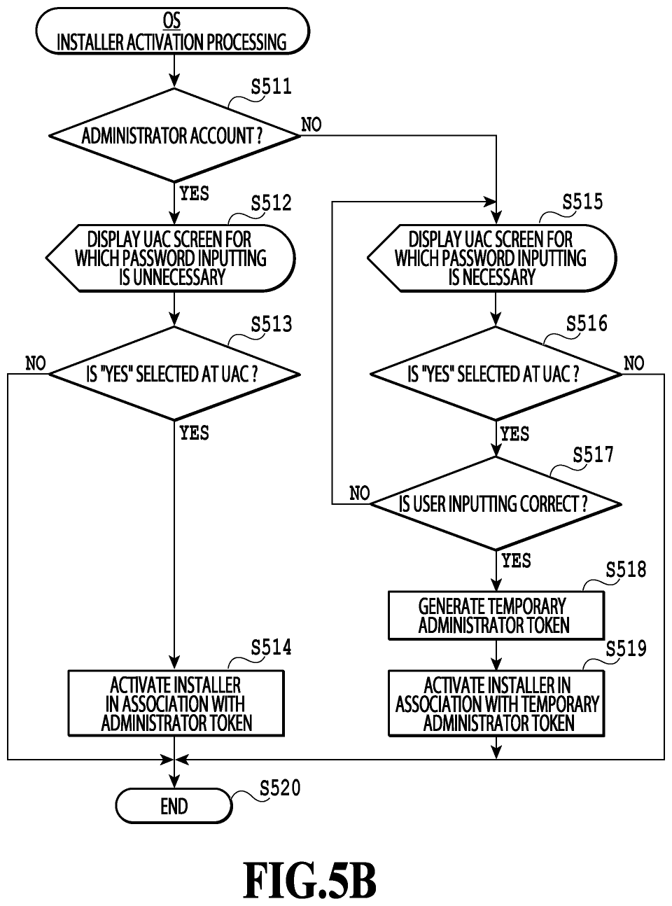

The CPU 111 executes the following steps based on a computer program of the installer. The CPU 111 starts the processing in FIG. 2 in accordance with activation of the installer through installer activation processing by the OS in FIG. 5B to be described later.

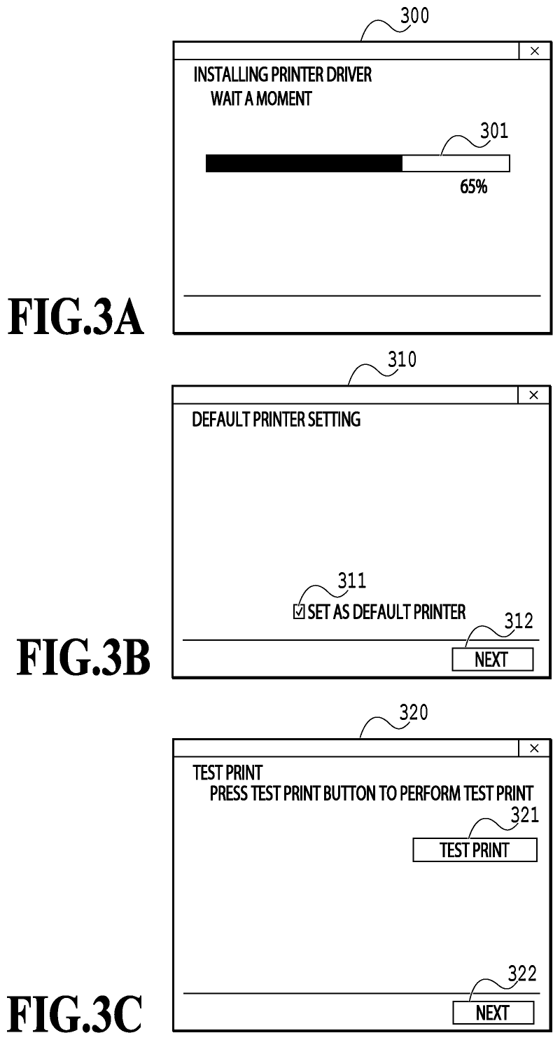

At S201, as illustrated in FIG. 3A, the CPU 111 displays a driver installation screen as a function of the installer. Specifically, the CPU 111 displays a driver installation screen 300 including a progress bar 301. The driver installation screen 300 will be described below with reference to FIG. 3A. The progress bar 301 in the driver installation screen 300 illustrates the progress of processing of printer driver installation and registration of the printer A120. When the processing of printer driver installation and registration of the printer A120 is completed and the progress bar 301 expires, the CPU 111 ends display of an installation screen 300 as illustrated in FIG. 2. Thereafter, the CPU 111 proceeds to processing at S202.

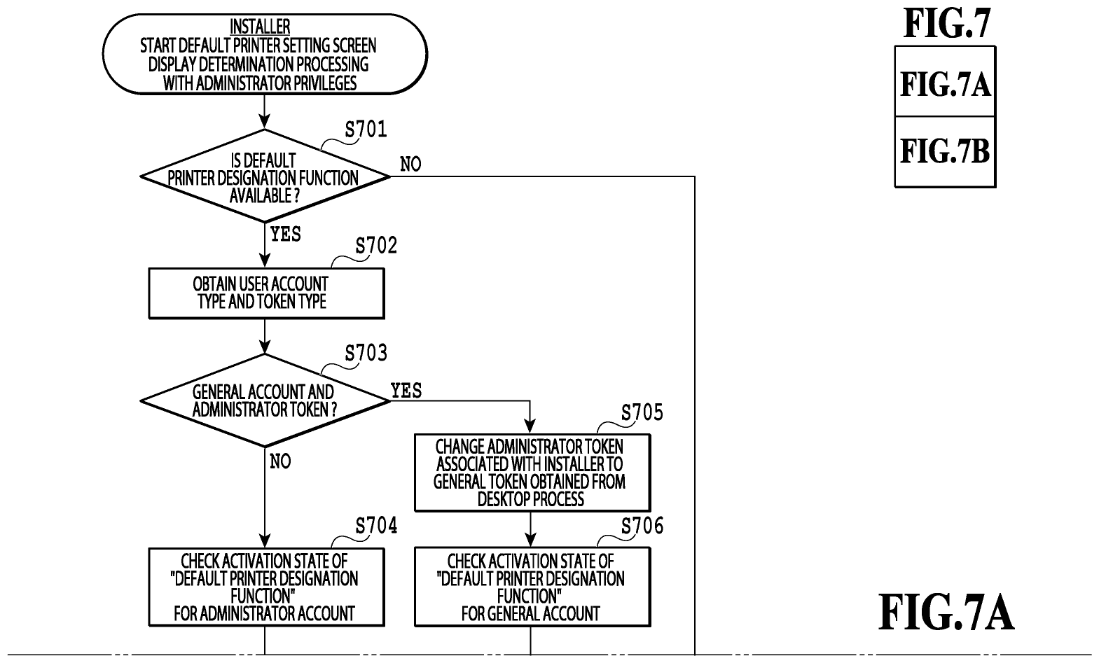

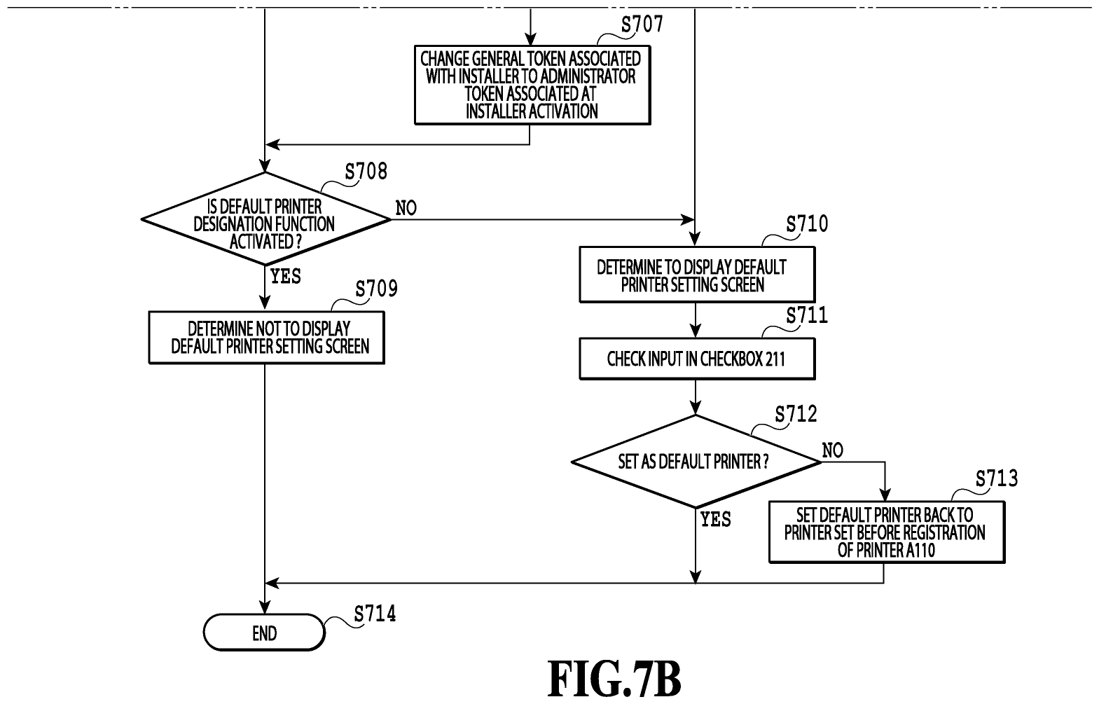

At S202, the CPU 111 executes default printer setting screen display determination processing as a function of the installer. Note that the default printer setting screen display determination processing will be described later with reference to FIG. 7. Thereafter, the CPU 111 proceeds to processing at S203.

At S203, the CPU 111 determines whether to display a default printer setting screen based on the determination processing at S202 as a function of the installer. The CPU 111 proceeds to processing at S204 when having determined to display the default printer setting screen (Yes), or proceeds to processing at S205 when having determined otherwise (No).

At S204, the CPU 111 displays the default printer setting screen as a function of the installer. Specifically, the CPU 111 performs display control to display a default printer setting screen 310 as illustrated in FIG. 3B to be described later. The CPU 111 ends display processing of the default printer setting screen when a “Next” button 312 in FIG. 3B is pressed down by a user. Thereafter, the CPU 111 proceeds to processing at S205.

At S205, the CPU 111 displays a test print screen as a function of the installer. Specifically, the CPU 111 displays a test print screen 320 as illustrated in FIG. 3C to be described later. Thereafter, the CPU 111 proceeds to processing at S206.

At S206, the CPU 111 ends the processing in FIG. 2 as a function of the installer. Specifically, the CPU 111 ends the processing in FIG. 2 when a “Next” button 322 on the test print screen 320 is pressed down by the user.

Screens displayed by the installer will be described below with reference to FIGS. 3A, 3B, and 3C. FIGS. 3A, 3B, and 3C are diagrams illustrating an example of a screen that the CPU 111 displays as a function of the installer.

FIG. 3A illustrates the driver installation screen 300 displayed by the installer during printer driver installation. The driver installation screen 300 includes the progress bar 301 illustrating the progress of processing of printer driver installation and registration of the printer A120. The user can check the progress of the installation with the progress bar 301. When the processing is completed and the progress bar expires, the installer displays the default printer setting screen 310 in FIG. 3B or the test print screen 320 in FIG. 3C in accordance with determination of whether to display a default printer setting screen in FIG. 7 to be described later. Specifically, the installer displays the default printer setting screen 310 when having determined to display the default printer setting screen, or displays the test print screen 320 when having determined not to display the default printer setting screen.

FIG. 3B illustrates the default printer setting screen 310 for the user to set the printer A120 as the default printer. The default printer setting screen 310 includes a check box 311 and the “Next” button 312. The check box 311 is a display item for receiving selection of whether to register the printer A120 registered in FIG. 3A as the default printer that is usually used. FIG. 3B illustrates a state in which the check box 311 is checked, indicating that the printer A120 is set as the default printer by the user. The “Next” button 312 is a button for receiving end of selection by the user. Specifically, when the “Next” button 312 is pressed down, the installer ends display processing of the default printer setting screen 310 and subsequently displays the test print screen 320 in FIG. 3C.

FIG. 3C illustrates the test print screen 320 for executing test print. The test print screen 320 includes a “Test Print” button 321 and the “Next” button 322. The “Test Print” button 321 is an instruction item for receiving execution of test print. When the “Test Print” button 321 is pressed down, the installer performs processing for executing test print at the printer A120 registered in accordance with a printing execution instruction of the installer. Test print is performed to check that the printer A120 registered earlier is capable of performing printing. The “Next” button 322 is a button for receiving end of test print execution by the user. Specifically, when the “Next” button 322 is pressed down, the installer ends display processing of the test print screen 320.

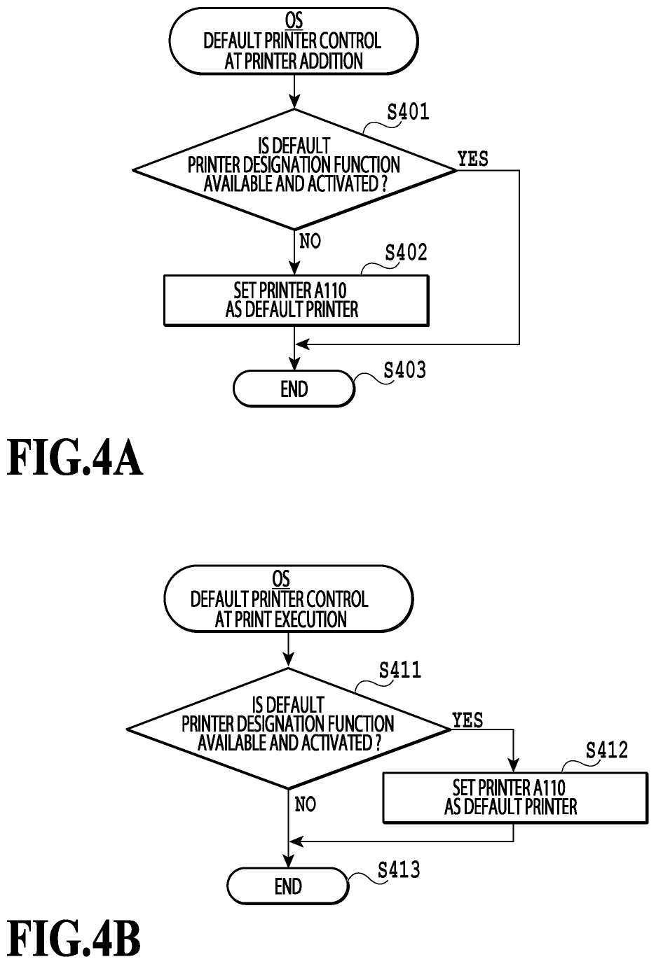

FIGS. 4A and 4B are flowcharts illustrating an example of processing that the CPU 111 executes as a function of the OS. Default printer control that the OS automatically performs will be described below with reference to FIGS. 4A and 4B. The OS processing in FIGS. 4A and 4B is achieved as the CPU 111 loads the computer program 118 stored in the ROM 112 onto the RAM 113 and executes the loaded computer program. The default printer control is executed when the CPU 111 newly registers a printer and/or when printing is performed by a registered printer. Note that default printer setting can be manually changed on an OS setting screen through a setting operation by the user when a default printer designation function is not activated. A computer program of the OS is referred to as a second computer program in some cases.

FIG. 4A is a flowchart illustrating an example of the default printer control when the OS receives an instruction to register the printer A120 from the installer after processing of printer driver installation and registration of the printer A120 is completed. The CPU 111 executes the following steps based on the computer program of the OS. The CPU 111 receives an instruction to register the printer A120 from the installer in FIG. 3A and starts the default printer control processing in FIG. 4A.

At S401, as a function of the OS, the CPU 111 is determines whether the default printer designation function is available and activated. In other words, the OS refers to the set value of a particular setting option indicating whether the default printer is to be managed by the OS. As for whether the default printer designation function is available, the OS executes the determination by checking whether support is available depending on the version of the OS or by using an OS API. OS API stands for Operating System Application Programming Interface. As for whether the default printer designation function is activated, the OS executes the determination by referring to a registry (to be described later) corresponding to a user account (to be described later) being currently logged in. The CPU 111 proceeds to processing at S403 when having determined the default printer designation function is available and activated (Yes), or proceeds to processing at S402 when having determined otherwise (No).

At S402, as a function of the OS, the CPU 111 sets the printer A120 as the default printer. Specifically, in a case where the default printer designation function is not available or not activated, the OS sets the printer A120 as the default printer. This is because, under control by the OS, a newly registered printer is set as the default printer based on an assumption that the newly registered printer is a printer that the user is intended to use. However, in a case where the default printer designation function is available and activated, simply registering the printer A120 does not cause the OS to set the printer A120 as the default printer. This is because, in a case where the default printer designation function is activated, a printer used last is set as the default printer and a printer registered by the user is set as the default printer when test print or the like is performed as described later. Thereafter, the CPU 111 proceeds to processing at S403.

At S403, as a function of the OS, the CPU 111 ends the default printer control processing. In the above description, the default printer control processing in FIG. 4A is executed by the OS after processing of printer driver installation and registration of the printer A120 is completed, but the present invention is not limited thereto. The default printer control processing may be executed at an optional timing by the user. For example, in a case where the default printer designation function is not activated, the OS may set the printer A120 as the default printer and then set a printer different from the printer A120 as the default printer upon a setting operation by the user.

FIG. 4B is a flowchart illustrating an example of the default printer control when the OS receives an instruction to execute test print by the printer A120 from the installer. The CPU 111 executes the following steps based on the computer program of the OS. The CPU 111 receives an instruction to issue a printing job to the printer A120 from the installer and starts the default printer control processing in FIG. 4B.

At S411, as a function of the OS, the CPU 111 determines whether the default printer designation function is available and activated. The method of the determination by the CPU 111 is the same as described with reference to FIG. 4A and thus description thereof is omitted. The CPU 111 proceeds to processing at S412 when having determined the default printer designation function is available and activated (Yes), or proceeds to processing at S413 when having determined otherwise (No).

At S412, as a function of the OS, the CPU 111 sets the printer A120 as the default printer. Thereafter, the CPU 111 proceeds to processing at S413.

At S413, as a function of the OS, the CPU 111 ends the default printer control processing. The series of processes in FIG. 4B are performed after execution of test print for checking that the printer A120 is capable of performing printing. Specifically, the OS sets the printer A120 as the default printer in a case where the default printer designation function of the OS is available and activated as a result of using the printer A120 in test print.

FIGS. 5A and 5B are flowcharts illustrating an example of activation processing of processes performed by the OS. The activation processing of processes performed by the OS will be described below with reference to FIGS. 5A and 5B. The processing by the OS in FIGS. 5A and 5B is achieved as the CPU 111 loads the computer program 118 stored in the ROM 112 onto the RAM 113 and executes the loaded computer program.

The relation between a user account and user privileges in the OS will be described below. User accounts are prepared by the OS to distinguish users of the PC. A user account can be registered to the OS by a user setting an ID, a password, and an account type (an administrator account or a general account) and is managed by the OS. Then, in login processing after OS activation to be described later, the user selects a user account set in advance and inputs the corresponding ID and password, thereby logging in with the selected user account. User privileges are allocated for each process executed by such as the installer at activation of the process by the OS. Then, the process is permitted to be processed in the range of the allocated user privileges. A process represents the unit of management of various computer programs (for example, the computer program 118) being activated in the RAM 113 by the OS. Pieces of processing in each process are managed in the unit of thread. Each thread is allocated with the same user privileges as a process that manages the thread.

FIG. 5A is a flowchart illustrating an example of login processing that the CPU 111 executes as a function of the OS at OS activation. The CPU 111 executes the following steps based on the computer program of the OS. When the PC 110 is turned on by a user, the CPU 111 executes an OS included in the external storage apparatus 119. Then, the CPU 111 executes the login processing in FIG. 5A.

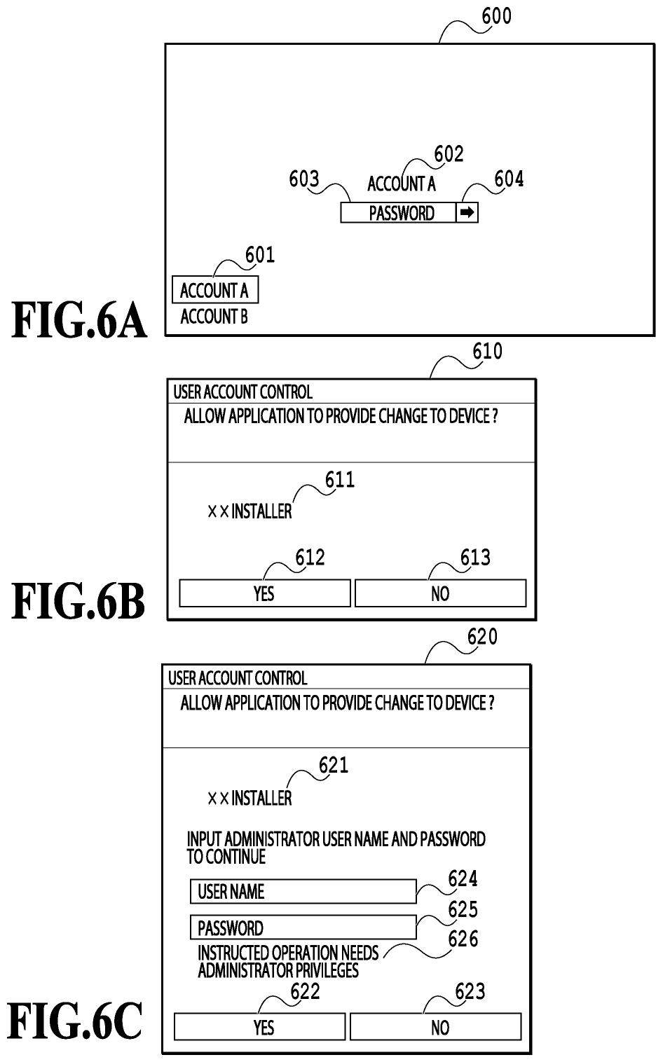

At S501, as a function of the OS, the CPU 111 displays a login screen. Specifically, the CPU 111 displays a login screen 600 as illustrated in FIG. 6A to be described later. In FIGS. 6A, 6B, and 6C, the user selects “account A” or “account B” as 601 and inputs a password in a password input region 603. Thereafter, when an authentication execution button 604 is pressed down by the user, the CPU 111 ends display processing of the login screen in FIG. 5A. Thereafter, the CPU 111 proceeds to processing at S502.

At S502, as a function of the OS, the CPU 111 determines whether the account selected by the user at S501 is an administrator account. The CPU 111 proceeds to processing at S503 when having determined the account selected by the user at S501 is an administrator account (Yes), or proceeds to processing at S504 when having determined otherwise (No).

At S503, as a function of the OS, the CPU 111 generates an administrator token and a general token and stores the generated tokens in the external storage apparatus 119. In this manner, an account for which the administrator token is generated by the OS at login is an administrator account. Thereafter, the CPU 111 proceeds to processing at S505.

Tokens will be described below. A token includes a security identifier (SID) for the OS to identify an account, and privilege information for accessing various kinds of setting and for changing various kinds of setting. The administrator token has higher privileges than the general token. In other words, the privilege level of privileges (first privileges) that the administrator token has is higher than that of privileges (second privileges) that the general token has. Each process refers to an SID stored in an allocated token and obtains information managed for each account by the OS. More specifically, the OS refers to a registry. The registry is a database managed by the OS. The registry stores various kinds of information such as information of system hardware, installed computer programs, and wallpaper setting. Among them, information managed for each user account is managed in a level for each SID described above. When accessing registry information managed for each user account, each process can obtain information corresponding to an SID included in a token allocated to the process. At process activation, the OS can provide different privileges for each process to be activated by associating the process with a token. Moreover, each process copies and inherits, for a thread managed by the process, a token associated with the process.

At S504, as a function of the OS, the CPU 111 generates the general token and stores the generated general token in the external storage apparatus 119. In this manner, an account for which the administrator token is not generated by the OS at login is a general account. Thereafter, the CPU 111 proceeds to processing at S505.

At S505, as a function of the OS, the CPU 111 activates a desktop process in association with the general token. Thereafter, the CPU 111 proceeds to processing at S506.

At S506, as a function of the OS, the CPU 111 ends the login processing in FIG. 5A.

The desktop process will be described below. The desktop process is a process that the OS activates first after login. The desktop process is a parent process that copies and inherits a token to all processes started by a user operation after the desktop process is started. The user operation is an operation such as double click on an icon (not illustrated) of the installer on desktop by the user. Thus, when the user activates a new process in a case of logging in with an administrator account, the process is associated with the general token. This is because, from a viewpoint of security, it is preferable to operate all processes with the administrator token. However, the installer in the present embodiment needs administrator privileges and thus needs to be activated in association with the administrator token. Thus, the installer has a setting file (manifest) in which it is defined that administrator privileges are required. When having referred to the manifest of the installer and determined that administrator privileges are needed, the OS activates a process of the installer in association with the administrator token. A specific method by which the OS activates a process of the installer in association with the administrator token will be described later.

FIG. 5B is a flowchart illustrating an example of installer activation processing that the CPU 111 executes as a function of the OS. The CPU 111 executes the following steps based on the computer program of the OS. When the OS is instructed to activate the installer by, for example, double click on the icon (not illustrated) of the installer on desktop by the user, the CPU 111 executes the installer activation processing in FIG. 5B.

At S511, as a function of the OS, the CPU 111 determines whether an account being logged in is an administrator account. The CPU 111 proceeds to S512 when having determined the account being logged in is an administrator account (Yes), or proceeds to S515 when having determined otherwise (No).

At S512, as a function of the OS, the CPU 111 displays a user account control screen for which password inputting is unnecessary. Specifically, in FIG. 6B, the CPU 111 displays a user account control (hereinafter referred to as UAC) screen 610 that includes a “Yes” button 612 and a “No” button 613 and for which password inputting is unnecessary. Hereinafter, the UAC screen 610 for which inputting of a user name and a password is unnecessary is defined as an administrator UAC 610. The administrator UAC 610 will be described later. The user presses down the “Yes” button 612 or the “No” button 613. In FIG. 5B, the CPU 111 ends display processing of the administrator UAC 610. Thereafter, the CPU 111 proceeds to processing at S513.

At S513, when having determined that the “Yes” button 612 is pressed down by the user at S512, in other words, activation processing with administrator privileges provided to the installer is to be continued (Yes), as a function of the OS, the CPU 111 proceeds to processing at S514. When having determined that the “No” button 613 is pressed down, in other words, activation processing with administrator privileges provided to the installer is not to be continued (No), the CPU 111 proceeds to processing at S520.

At S514, as a function of the OS, the CPU 111 activates the installer in association with the administrator token generated and stored in the external storage apparatus 119 at S503. Thereafter, the CPU 111 proceeds to processing at S520.

At S515, as a function of the OS, the CPU 111 displays a screen for which inputting of a user name and a password is necessary. Specifically, in FIG. 6C, the CPU 111 displays an UAC screen 620 that includes a “Yes” button 622 and a “No” button 623 and for which inputting of a user name and a password is necessary. Hereinafter, the UAC screen 620 for which inputting of a user name and a password is necessary is defined as a general UAC 620. When agreeing that an application displayed in a target application name display region 621 is to be provided and activated with administrator privileges, the user inputs the user name and password of an administrator account in an user name input region 624 and a password input region 625. In FIG. 5B, when the “Yes” button 622 or the “No” button 623 is pressed down by the user, the CPU 111 ends display processing of the general UAC 620. Thereafter, the CPU 111 proceeds to processing at S516.

At S516, as a function of the OS, when having determined that the “Yes” button 622 is pressed down by the user at S515, in other words, activation processing with administrator privileges provided to the installer is to be continued (Yes), the CPU 111 proceeds to processing at S517. When having determined that the “No” button 623 is pressed down by the user at S515, in other words, activation processing with administrator privileges provided to the installer is not to be continued (No), the CPU 111 proceeds to processing at S520.

At S517, as a function of the OS, the CPU 111 determines whether the user name and the password that are input by the user in the user name input region 624 and the password input region 625 at S515 are correct. Specifically, the CPU 111 determines whether the user name input in the user name input region 624 is of an administrator account and the password input in the password input region 625 corresponds to the user name input in the user name input region 624. At S517, the CPU 111 proceeds to processing at S518 when having determined that the input user name and password are correct (Yes), or proceeds to processing at S515 again when having determined otherwise (No).

Again at S515, as a function of the OS, the CPU 111 displays the general UAC 620 and displays a corresponding error message in an error text display region 626 of the general UAC 620. For example, in the general UAC 620 illustrated in FIG. 6C, the user name and password of a general account are input in the user name input region 624 and the password input region 625. In this case, the CPU 111 cannot generate the administrator token and thus displays, in the error text display region 626, error text indicating that an administrator account is necessary. Thereafter, the CPU 111 proceeds to processing at S516 again. Note that S516 again is the same processing as S516.

At S518, as a function of the OS, the CPU 111 generates a temporary administrator token based on the user name and the password input by the user at S515. The CPU 111 does not store the administrator token generated at S518 in the external storage apparatus 119. This is because, from a viewpoint of security, in the PC 110 logged in with a general account, execution of processing for which administrator privileges are necessary is limited to the user with which the user ID and password of an administrator account are shared. Thereafter, the CPU 111 proceeds to processing at S519.

At S519, as a function of the OS, the CPU 111 activates the installer in association with the temporary administrator token generated at S518. Thereafter, the CPU 111 proceeds to processing at S520.

At S520, as a function of the OS, the CPU 111 ends the installer activation processing in FIG. 5B. In this manner, the OS displays the general UAC 620 in a case of login with a general account. Then, in accordance with inputting by the user, the OS activates the installer in association with the administrator token having the first privileges. Specifically, since the installer cannot be activated with the second privileges at login, the user performs an operation on a UAC screen for elevation to the first privileges and the OS activates the installer.

FIGS. 6A, 6B, and 6C are diagrams illustrating an example of screen display by the OS. The screen display by the OS will be described below with reference to FIGS. 6A, 6B, and 6C. FIG. 6A is a diagram illustrating an example of the login screen 600 that the CPU 111 displays as a function of the OS after execution of the login processing in FIG. 5A. The login screen 600 includes an account selection region 601, a selected account name display region 602, the password input region 603, and the authentication execution button 604. The login screen 600 illustrates a state in which “account A” is selected. The user selects “account A” to log in with “account A”, inputs a password in the password input region 603, and presses down the authentication execution button 604. When the user selects “account B” in the account selection region 601 to log in with “account B”, display of the selected account name display region 602 switches to “account B”. Then, the user inputs the password of “account B” in the password input region 603 and presses down the authentication execution button 604.

FIG. 6B is a diagram illustrating an example of the administrator UAC 610. The administrator UAC 610 includes a target application name display region 611, the “Yes” button 612, and the “No” button 613. The user presses down the “Yes” button 612 when agreeing that an application displayed in the target application name display region 611 is to be provided with administrator privileges and activated, or presses down the “No” button 613 when not agreeing. When either button is pressed down by the user, the OS executes determination processing at S513.

FIG. 6C is a diagram illustrating an example of the general UAC 620. The general UAC 620 includes the target application name display region 621, the “Yes” button 622, the “No” button 623, the user name input region 624, the password input region 625, and the error text display region 626. When agreeing that an application displayed in the target application name display region 621 is to be provided and activated with administrator privileges, the user inputs the user name and password of an administrator account in the user name input region 624 and the password input region 625. The user presses down the “Yes” button 622 when agreeing that an application displayed in the target application name display region 621 is to be provided with administrator privileges and activated, or presses down the “No” button 623 when not agreeing. When either button is pressed down by the user, the OS executes determination processing at S516.

FIG. 7 is a flowchart illustrating an example of the default printer setting screen display determination processing that the CPU 111 executes as a function of the installer. The default printer setting screen display determination processing by the installer will be described below with reference to FIG. 7. Specifically, specific processing by the installer at S202 in FIG. 2 will be described below. The processing by the installer in FIG. 7 is achieved as the CPU 111 loads the computer program 118 stored in the ROM 112 onto the RAM 113 and executes the loaded computer program. The CPU 111 executes the following steps based on the computer program of the installer. The CPU 111 starts the default printer setting screen display determination processing.

At S701, as a function of the installer, the CPU 111 determines whether the default printer designation function is available at the OS. The determination of whether the default printer designation function at S701 is available is achieved, for example, by checking whether support is available depending on the version of the OS or by using an OS API. The CPU 111 proceeds to processing at S702 when having determined the default printer designation function is available at the OS (Yes), or proceeds to processing at S710 when having determined otherwise (No).

At S702, as a function of the installer, the CPU 111 obtains the account type of a user being logged in and the type of a token associated with a process of the installer. The obtainment of the account type of a user being logged in and the kind of a token associated with a process of the installer at S702 is achieved by, for example, an OS API. Thereafter, the CPU 111 proceeds to processing at S703.

At S703, as a function of the installer, the CPU 111 determines whether the account of a user being logged in is a general account and a token associated with a process of the CPU 111 is the administrator token. The CPU 111 proceeds to processing at S705 when having determined the account of the user being logged in is a general account and the token associated with a process of the installer is the administrator token (Yes), or proceeds to processing at S704 when having determined otherwise (No).

At S704, as a function of the installer, the CPU 111 checks the activation state of the default printer designation function managed in association with an administrator account. Specifically, the installer executes the above-described check processing in a case where the first privileges associated with an administrator account at login are equivalent to the privileges of the administrator token associated with the installer activated through an operation on a UAC screen by the user. The activation state of the default printer designation function at S704 is achieved by, for example, referring to the registry with an OS API and obtaining information indicated by a key “LegacyDefaultPrinterMode”. Thereafter, the CPU 111 proceeds to processing at S708.

At S705, as a function of the installer, the CPU 111 copies the general token associated with the desktop process in FIG. 5A and changes a token associated with a thread being currently processed at the installer to the copied general token. A typical installer not according to the present disclosure uses a token associated with the thread when referring to the activation state of the default printer designation function managed for each account. Accordingly, the typical installer uses the administrator token to refer to the activation state of the default printer designation function associated with an administrator account. Thus, the typical installer refers to the activation state of the default printer designation function with an administrator account even when the user is logged in with a general account. As a result, appropriate display is not performed in some cases. In the present embodiment, processing that the installer temporarily changes a token associated with a thread of the installer to the general token is performed at S705. Through the processing, the installer can appropriately refer to the activation state of the default printer designation function for a general account being logged in. Note that the copying of the general token associated with the desktop process by the installer and/or the association of the copied general token with a thread of the installer at S705 are achieved by, for example, an OS API. Thereafter, the CPU 111 proceeds to processing at S706.

At S706, as a function of the installer, the CPU 111 checks the activation state of the default printer designation function managed in association with a general account. Thereafter, the CPU 111 proceeds to processing at S707.

At S707, as a function of the installer, the CPU 111 changes the general token temporarily changed at S705 back to the original administrator token associated at installer activation. Accordingly, the installer possesses the administrator token again even when administrator privileges are necessary for processing at S707 or later, and thus can perform processing for which administrator privileges are required. Note that the processing at S707, which changes the general token associated at S705 back to the original administrator token associated at installer activation, is achieved by, for example, an OS API. Thereafter, the CPU 111 proceeds to processing at S708.

At S708, as a function of the installer, the CPU 111 determines whether the default printer designation function is activated. Specifically, after the processing at S704, the CPU 111 determines whether the default printer designation function with an administrator account is activated. Alternatively, after the processing at S705, the CPU 111 determines whether the default printer designation function with a general account is activated. The CPU 111 proceeds to processing at S709 when having determined the default printer designation function is activated (Yes), or proceeds to processing at S710 when having determined otherwise (No).

At S709, as a function of the installer, the CPU 111 determines that the default printer setting screen 310 is not to be displayed. Thereafter, the CPU 111 proceeds to processing at S714. Specifically, the installer does not display the default printer setting screen 310 in a case where the default printer designation function is activated. Accordingly, since the installer does not display the default printer setting screen, it is possible to prevent unintended default printer setting by the user.

At S710, as a function of the installer, the CPU 111 determines that the default printer setting screen 310 is to be displayed. Thereafter, the CPU 111 proceeds to processing at S711. Specifically, the installer displays the default printer setting screen 310 in a case where the default printer designation function is not activated. Accordingly, the user can select whether the printer A120 corresponding to an installed printer driver is to be set as the default printer.

At S711, as a function of the installer, the CPU 111 checks a user input received in the check box 311 on the default printer setting screen 310. Specifically, the CPU 111 checks a user input when the default printer setting screen 310 in FIG. 3B is displayed and the “Next” button 312 is pressed down by the user. Thereafter, the CPU 111 proceeds to processing at S712.

At S712, as a function of the installer, the CPU 111 determines whether the printer A120 is to be set as the default printer. Specifically, the CPU 111 executes the processing at S712 when the “Next” button 312 in FIG. 3B is pressed down by the user. The CPU 111 proceeds to S714 to when having determined the check box 311 is checked, in other words, the printer A120 is to be set as the default printer (Yes), or proceeds to S713 when having determined otherwise (No).

At S713, as a function of the installer, the CPU 111 sets the default printer back to a state before the printer A120 is registered. Thereafter, the CPU 111 proceeds to processing at S714. In a case where the default printer designation function is not activated, the printer A120 newly registered by the OS is automatically set as the default printer as described above with reference to FIG. 4A. Thus, additional processing by the installer is unnecessary in a case where it is determined that the printer A120 is to be set as the default printer at S712. However, the processing at S713 by the installer is needed in a case where it is determined that the printer A120 is not to be set as the default printer at S712. Specifically, before installing a driver corresponding to the printer A120, the installer obtains the printer icon name of the printer B130 as information of the default printer (for example, the printer B130) being currently set. Thereafter, the installer sets the default printer back to the printer B130 from the registered printer A120 by using the obtained printer icon name of the printer B130. The obtainment of the printer icon name of the printer B130 is achieved by, for example, an OS API. Similarly to the activation state of the default printer designation function, the default printer information is managed for each account by the OS. Thus, the installer may perform the processing at S705 before obtaining the default printer information and perform the processing at S707 after obtaining the default printer information. Then, at S713, the installer newly designates and sets the printer B130 as the default printer by using an OS API. Alternatively, at S713, the installer may perform the processing at S705 again to obtain the default printer information and thereafter perform the processing at S707 again. The obtainment of the default printer information is achieved by an OS API.

At S714, as a function of the installer, the CPU 111 ends the default printer setting screen display determination processing in FIG. 7.

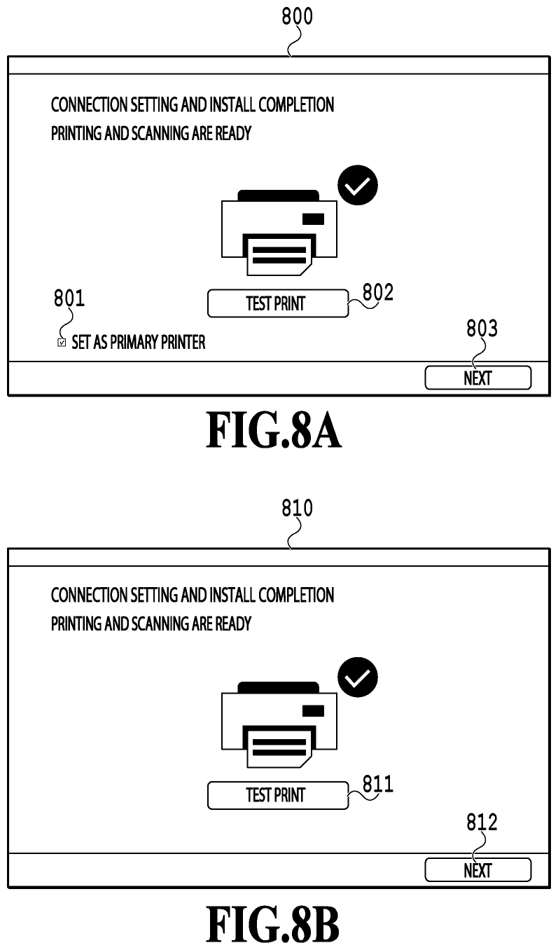

Screens displayed in the present embodiment are, for example, FIGS. 3A, 3B, and 3C in the above description but are not limited thereto. For example, the installer may display a screen in FIG. 8A or 8B after printer driver installation is completed. FIGS. 8A and 8B are diagrams illustrating an example of a screen that the CPU 111 displays as a function of the installer. Screens displayed by the installer will be described below with reference to FIGS. 8A and 8B. FIG. 8A illustrates a test print screen 800 displayed by the installer in a case where the installer performs determination with “No” at S701 or S708 and including “Set as primary printer” display including a check box 801. In other words, the screen of FIG. 8A is the test print screen 320 in FIG. 3C displayed with the check box 311 in FIG. 3B. The test print screen 800 includes the check box 801, a test print button 802, and a “Next” button 803. FIG. 8B illustrates a test print screen 810 not including the “Set as primary printer” display in FIG. 8B in a case where the installer determines that the default printer designation function is activated (Yes) at S708. The test print screen 810 includes a test print button 811 and a “Next” button 812. The “Set as primary printer” 801 has the same meaning as the above-described “set as default printer”.

At S702 in the present embodiment, the account type of a user and the type of a token are obtained, but the type of a token does not necessarily need to be obtained since the installer in the present embodiment is a process for which administrator privileges are required. In this case, at S703, the installer performs determination of whether the user account type obtained at S702 is an administrator account in place of the determination at S703. The installer proceeds to the processing at S704 in a case where the user account type obtained at S702 is an administrator account. The installer proceeds to the processing at S705 in a case where the user account type obtained at S702 is not an administrator account. Moreover, the installer proceeds to the processing at S705 only in the case of “Yes” at S703 in the present embodiment but may perform the processing at S705 in any environment instead of performing the determination at S703. In a case where the determination at S703 is “No”, the SID of a token associated with a process of the installer matches the SID of a token associated with the desktop process. Thus, the installer can correctly obtain the activation state of the default printer designation function even in a case where the processing at S705, S706, and S707 is executed in the case of No at S703. However, in an environment where the determination at S703 is “No”, a token associated with a process of the installer does not need to be changed to a token associated with the desktop process. Thus, in processing described in the present embodiment, the installer does not need to perform redundant processing in an environment where the determination at S703 is “No”, and this is an advantage.

As described above, according to the present embodiment, even when activated with administrator privileges by a user with a general account, the installer can set the default printer in accordance with whether the default printer designation function associated with a general account is activated. Specifically, the installer displays the default printer setting screen 310 in a case where the default printer designation function is not available or in a case where the default printer designation function is not activated. However, the installer does not display the default printer setting screen 310 in a case where the default printer designation function is available and activated, thereby preventing a function of setting the default printer from being executed by the user. Accordingly, it is possible to prevent the default printer from being changed due to execution of test print even when the user checks off the check box 311 to designate that the default printer is not to be changed.

### Second Embodiment

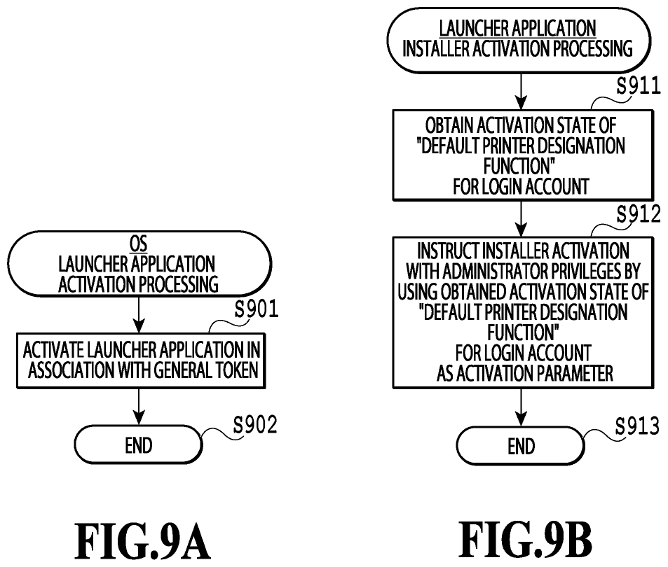

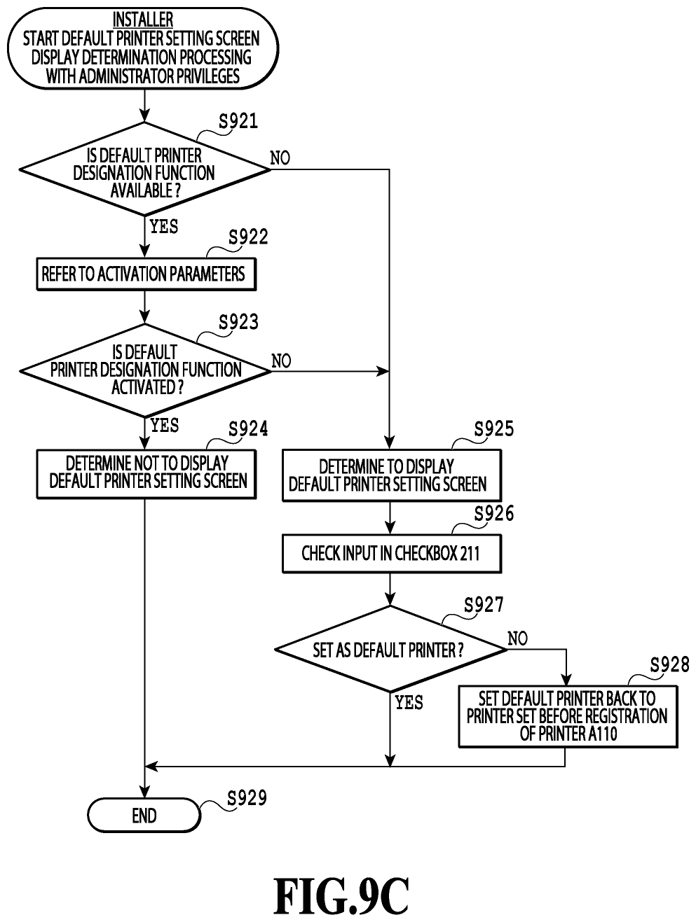

Difference of a second embodiment from the first embodiment will be described below with reference to FIGS. 9A, 9B, and 9C. FIGS. 9A, 9B, and 9C are flowcharts illustrating an example of processing that the CPU 111 determines whether to display the default printer setting screen as a function of the installer when another application different from the installer is associated and activated with the general token. In the present embodiment, a launcher application that has a function to activate the installer and does not need administrator privileges will be described as an example of another application different from the installer. Similarly to the installer, the launcher application is stored in the ROM 112 and achieved as the CPU 111 loads the computer program 118 from the ROM 112 onto the RAM 113 and executes the loaded computer program. Note that a symbol “S” in the following description of each processing means processing (step) in FIGS. 9A, 9B, and 9C.

FIG. 9A is a flowchart illustrating an example of launcher application activation processing that the CPU 111 executes as a function of the OS. The CPU 111 executes the following steps based on the computer program of the OS. The CPU 111 starts the processing in FIG. 9A when a user instructs the OS to activate the launcher application by, for example, double click an icon (not illustrated) of the launcher application on desktop.

At S901, as a function of the OS, the CPU 111 activates the launcher application in association with the general token generated at S503 or S504. Thereafter, the CPU 111 proceeds to processing at S902.

At S902, as a function of the OS, the CPU 111 ends the launcher application activation processing in FIG. 9A.

FIG. 9B is a flowchart illustrating an example of the installer activation processing of the launcher application activated at S901, which the CPU 111 executes as a function of the launcher application. The CPU 111 executes the following steps based on a computer program of the launcher application. The CPU 111 starts the processing in FIG. 9B.

At S911, as a function of the launcher application, the CPU 111 obtains the activation state of the default printer designation function for an account being currently logged in and the printer icon name of a printer being currently set as the default printer. The printer being currently set as the default printer is, for example, the printer B130. The obtainment of the activation state of the default printer designation function for an account being currently logged in and the printer icon name of a printer currently set as the default printer is achieved by, for example, an OS API. Thereafter, the CPU 111 proceeds to processing at S912.

At S912, as a function of the launcher application, the CPU 111 instructs the OS to activate the installer with administrator privileges. Thereafter, the CPU 111 proceeds to processing at S913.

At S913, as a function of the launcher application, the CPU 111 ends the installer activation processing in FIG. 9B. Note that the activation instruction may include activation parameters that are string information defined for the launcher application and the installer in advance. Thus, in the present embodiment, the activation state of the default printer designation function for an account being currently logged in and the printer icon name of the printer B130, which are obtained by the launcher application at S911, are set as the activation parameters. Having received the activation instruction with administrator privileges at S912, the OS executes the processing in FIG. 5B.

FIG. 9C is a flowchart illustrating an example of display determination processing that the CPU 111 executes as a function of the installer for the default printer setting screen 310 of the installer activated with administrator privileges at S912. Note that processing at S921 and S923 to S929 is the same as the processing at S701 and S708 to S714 in FIG. 7, and thus description thereof is omitted. The CPU 111 executes the following steps based on the computer program of the installer. The CPU 111 starts the processing in FIG. 9C.

At S922, as a function of the installer, the CPU 111 refers to the activation parameters passed as activation parameters from the launcher application. Specifically, the CPU 111 refers to the activation state of the default printer designation function for the account, which is obtained by the launcher application at S911. Thereafter, the CPU 111 proceeds to processing at S923.

The CPU 111 executes the processing at S923 to S928 based on contents checked at S922 and ends the default printer setting screen display determination processing in FIG. 9C at S929.

As described above, according to the present embodiment, it is possible to obtain the same effects as the first embodiment without changing a token associated with a thread of the installer in a case of an application constituted by a plurality of processes. Note that, in the present embodiment, the activation state of the default printer designation function for an account being logged in is passed as an activation parameter from the launcher application to the installer, but the present invention is not limited thereto. The installer may activate the launcher application at a predetermined timing by using an activation parameter defined to be activated as a dedicated mode for obtaining the activation state of the default printer designation function for an account being logged in. After activating the launcher application, the installer may obtain the activation state of the default printer designation function for an account being logged in. Alternatively, the launcher application may be continuously activated after the launcher application instructs the OS to activate the installer at S912. Thereafter, at a predetermined timing, the installer may execute inter-process communication with the launcher application and instruct the launcher application to check the activation state of the default printer designation function for an account being currently logged in.

Note that various kinds of control performed by the CPU 111 in the above description may be performed by one hardware component. Processing may be distributed to a plurality of hardware components (for example, a plurality of processors and circuits) to control the entire apparatus. Although the present disclosure is described above in detail based on preferable embodiments thereof, the present disclosure is not limited to these particular embodiments. The present disclosure also includes various forms within the scope of the present disclosure. Each embodiment described above merely represents an embodiment of the present disclosure, and the embodiments may be combined as appropriate.

Although the embodiments are described above with an example in which the present disclosure is applied to a PC, the embodiments are not limited to the example but are also applicable to an information processing apparatus, for example, a tablet terminal. The embodiments are applicable to any instrument with minimum prerequisites of the present disclosure to the extent that feasible requirements are satisfied.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to correctly refer to the state of a default printer designation function for each account and execute screen display processing appropriately.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-105202, filed Jun. 27, 2023, which is hereby incorporated by reference herein in its entirety.

What is claimed is:

1. A non-transitory computer-readable storage medium storing a program for causing a computer to perform:
control to install a predetermined printer driver with first privilege;
referring to a set value of a particular setting option with second privilege different from the first privilege, the particular setting option indicating whether a default printer is to be managed by an operating system (OS); and
controlling display of a display item for receiving an instruction related to whether to set a predetermined printer corresponding to the predetermined printer driver as the default printer in accordance with the referred set value of the particular setting option.

2. The non-transitory computer-readable storage medium according to claim 1, wherein the display item is controlled not to be displayed in a case where the referred set value of the particular setting option is set such that the default printer is managed by the OS.

3. The non-transitory computer-readable storage medium according to claim 1, wherein
the predetermined printer is not set as the default printer in accordance with the installation in a case where the referred set value of the particular setting option is set such that the default printer is managed by the OS, and
the predetermined printer is set as the default printer in accordance with the installation in a case where the referred set value of the particular setting option is not set such that the default printer is managed by the OS.

4. The non-transitory computer-readable storage medium according to claim 3, wherein
control is performed to display an instruction item for instructing printing by the predetermined printer after the installation, and
the predetermined printer is set as the default printer in accordance with execution of printing by the predetermined printer based on an operation on the instruction item by a user in a case where the referred set value of the particular setting option is set such that the default printer is managed by the OS.

5. The non-transitory computer-readable storage medium according to claim 3, wherein the predetermined printer is set as the default printer in accordance with the installation without an operation for setting as the default printer by a user in a case where the referred set value of the particular setting option is not set such that the default printer is managed by the OS.

6. The non-transitory computer-readable storage medium according to claim 5, wherein control is performed to set the default printer back to a setting state before setting to the predetermined printer in accordance with the installation when a user operation corresponding to an instruction not to set the predetermined printer as the default printer is performed on the display item in a case where the referred set value of the particular setting option is not set such that the default printer is managed by the OS.

7. The non-transitory computer-readable storage medium according to claim 1, wherein control is performed to display the display item in a case where the referred set value of the particular setting option is not set such that the default printer is managed by the OS.

8. The non-transitory computer-readable storage medium according to claim 1, wherein the set value of the particular setting option is referred by changing the first privilege to the second privilege.

9. The non-transitory computer-readable storage medium according to claim 1, wherein the set value of the particular setting option is referred with the second privilege in a process different from the installation with the first privilege.

10. The non-transitory computer-readable storage medium according to claim 1, wherein the first privilege have a higher privilege level than the second privilege.

11. The non-transitory computer-readable storage medium according to claim 1, wherein
control is performed to install the predetermined printer driver after setting the first privilege in accordance with a user operation on a user account control (UAC) screen displayed by a function of an operation system (OS), and
the second privilege are privilege before the user operation on the UAC screen.

12. The non-transitory computer-readable storage medium according to claim 11, wherein the set value of the particular setting option is referred with the first privilege in a case where the privilege before the user operation on the UAC screen are equivalent to the first privilege.

13. The non-transitory computer-readable storage medium according to claim 1, wherein the particular setting option is an OS setting option corresponding to Legacy Default Printer Mode.

14. The non-transitory computer-readable storage medium according to claim 1, wherein the set value of the particular setting option is referred by changes a token having the first privilege to a token having the second privilege copied by a function of an installer.

15. An information processing apparatus comprising:
at least one memory and at least one processor which function as:
a control unit configured to perform control to install a predetermined printer driver with first privilege;
a referring unit configured to refer to a set value of a particular setting option with second privilege different from the first privilege, the particular setting option indicating whether a default printer is to be managed by an operating system (OS); and
a display control unit configured to control display of a display item for receiving an instruction related to whether to set a predetermined printer corresponding to the predetermined printer driver as the default printer in accordance with the set value of the particular setting option referred by the referring unit.

16. An information processing method comprising the steps of:
performing control to install a predetermined printer driver with first privilege;
referring to a set value of a particular setting option with second privilege different from the first privilege, the particular setting option indicating whether a default printer is to be managed by an OS; and
controlling display of a display item for receiving an instruction related to whether to set the predetermined printer corresponding to the predetermined printer driver as the default printer in accordance with the referred set value of the particular setting option.
